(19) United States
(12) Patent Application Publication
(10) Pub. No.: US 2026/0089375 A1
(43) Pub. Date: Mar. 26, 2026

(54) ACTUATOR FOR CAMERA

(71) Applicant: JAHWA ELECTRONICS Co., Ltd., cheongju-si (KR)

(72) Inventors: Hee Seung KIM, cheongju-si (KR); In Soo KIM, cheongju-si (KR); Ki Hoon JEON, cheongju-si (KR)

(21) Appl. No.: 19/272,764

(22) Filed: Jul. 17, 2025

(30) Foreign Application Priority Data
Sep. 25, 2024 (KR) 10-2024-0129516

(51) Int. Cl. H04N 23/54; G03B 13/36

(52) U.S. Cl. CPC H04N 23/54; G03B 13/36

(57) ABSTRACT

An actuator for a camera according to an embodiment of the present disclosure includes a housing configured to provide an inner space; a carrier configured to move in an optical axis direction based on the housing; a magnet installed in the carrier to face a coil installed in the housing; a yoke plate installed in the housing and configured to generate an attractive force with the magnet; and a ball disposed between the housing and the carrier. In this case, a height of the yoke plate is greater than the sum of a height of the magnet and a stroke, which is a moving distance of the carrier by AF driving.

### TECHNICAL FIELD

The present disclosure relates to an actuator for a camera, and more specifically, to an actuator for a camera, which further improves the driving precision and stability of a carrier.

### BACKGROUND ART

Advances in hardware technology for image processing and growing consumer need for making and taking photos and videos have driven implementation of such functions as autofocusing (AF) and optical image stabilization (OIS) in stand-alone cameras as well as camera modules mounted on mobile terminals including cellular phones and smartphones.

An autofocus (AF) function (or, an automatically focusing function) means a function of a focal length to a subject by linearly moving a carrier having a lens in an optical axis direction to generate a clear image at an image sensor (CMOS, CCD, etc.) located at the rear of the lens.

An optical image stabilization (OIS) function means a function of improving the sharpness of an image by adaptively moving the carrier having a lens in a direction to compensate for the shaking when the lens is shaken due to trembling.

One typical method for implementing the AF or OIS function is to install a magnet (a coil) on a mover (a carrier) and install a coil (a magnet) on a stator (a housing, or another type of carrier, or the like), and then generate an electromagnetic force between the coil and the magnet so that the mover moves in the optical axis direction or in a direction perpendicular to the optical axis.

An actuator in which AF is implemented independently, as well as an actuator in which AF is implemented integrally with OIS, includes a ball placed between a relative stator (housing, etc.) and a mover (carrier, etc.).

AF is implemented as the carrier, which is a mover, moves forward and backward in the optical axis direction based on the housing, which is a relative stator, while receiving physical support or guidance from the ball. The area or range (length) through which the mover moves in the optical axis direction to implement AF is referred to as stroke in this technical field.

In the case where a ball is involved in the driving of the AF, a magnet provided in the mover and a yoke plate that generates an attractive force are installed in the stator to increase the adhesion between the ball and the mover and between the ball and the stator.

When the carrier moves in the optical axis direction, the yoke plate is installed in the housing, which is a relative stator, so its movement is fixed, whereas the magnet installed in the carrier moves together with the carrier, so the relative positional relationship between the magnet and the yoke changes over time (time variant).

When the AF is driven, the ball placed between the mover and the stator does not maintain a fixed position but changes its position while having a certain range of movement. The fact that the position of the ball changes due to the AF drive in this way means that the position where the carrier, which is a mover, is physically supported by the ball changes over time.

Since the positional relationship between the magnet and the yoke as well as the position at which the mover is physically supported by the ball changes over time in this way, the postural equilibrium of the carrier may be disrupted depending on the operation range or position of the carrier, resulting in defects such as the carrier tilting. This phenomenon is relatively more likely to occur in an actuator equipped with a heavy lens with a long stroke.

### SUMMARY

### Technical Problem

The present disclosure is designed to solve the problems of the related art, and therefore the present disclosure is directed to providing an actuator for a camera, which may further improve the driving precision of AF by precisely implementing the structural relationship between components that implement physical support and guiding of a carrier.

Other technical goals and advantages of the present invention can be understood with reference to the description below, which will be made explicit by the accompanied examples. Furthermore, the technical goals and advantages of the present invention can be accomplished by the embodiments and their combinations recited in the attached claims.

### Technical Solution

An actuator for a camera according to an embodiment of the present disclosure to accomplish the above object comprises a housing configured to provide an inner space; a carrier configured to move in an optical axis direction based on the housing; a magnet installed in the carrier to face a coil installed in the housing; a yoke plate installed in the housing and configured to generate an attractive force with the magnet; and a ball disposed between the housing and the carrier.

In this case, a height of the yoke plate of the present disclosure is greater than the sum of a height of the magnet and a stroke, which is a moving distance of the carrier by AF driving.

In addition, the ball of the present disclosure may be provided in plurality so that the plurality of balls are arranged in the optical axis direction, and a first distance, which is the sum of a total height of the plurality of balls and the stroke, may be smaller than the sum of a radius of a contrast ball, which is one of the plurality of balls, and the height of the yoke plate.

Here, the contrast ball of the present disclosure may be a ball placed at an outermost side among the plurality of balls, and the ball placed at the outermost side may be a ball with a largest diameter among the plurality of balls.

According to an embodiment, the ball of the present disclosure may include a first ball group arranged between the carrier and the housing; and a second ball group arranged between the carrier and the housing and arranged parallel to the first ball group based on the optical axis direction.

In this case, at least one of the first and second ball groups may include a plurality of balls, and the sum of the stroke and a height of a support ball group, which is a ball group with a larger total height among the first and second ball groups, may be smaller than the sum of a radius of a ball placed at an outermost side among the balls belonging to the support ball group and the height of the yoke plate.

In addition, the height of the magnet may be smaller than the sum of a total height of the plurality of balls and a radius of a ball placed at an outermost side among the plurality of balls.

### Advantageous Effects

According to the present disclosure, tilt phenomena that may occur when the carrier moves may be effectively suppressed, and changes in the posture of the carrier may be minimized, thereby improving the precision and operational stability of AF operation.

According to an embodiment of the present disclosure, the height of the magnet and the yoke plate that generates the attractive force is determined by considering the movement area (stroke) of the magnet and the carrier on which the magnet is installed, so that the stator and the mover with the ball interposed therebetween may be more stably brought into close contact.

According to an embodiment of the present disclosure, the stroke, etc. is determined by considering the point at which the physical support of the carrier is provided and the radius size of the ball arranged at the outermost side, so that the carrier may be more stably supported and guided by the ball throughout the entire section in which the AF is driven.

According to an embodiment of the present disclosure, the height of the magnet in the optical axis direction is determined based on the total height of the balls and the radius size of the outermost side ball, so that the height of the magnet for increasing the driving force may be optimized.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a drawing showing the configuration of an actuator according to a preferred embodiment of the present disclosure,

FIGS. 2 and 3 are drawings for explaining a ball, a first rail, and a second rail shown in FIG. 1,

FIG. 4 is a partial cross-sectional view showing the ball and a yoke plate, and

FIG. 5 is a drawing for explaining the structural relationship between the yoke plate, the ball, the magnet, and the stroke.

### DETAILED DESCRIPTION OF EXEMPLARY EMBODIMENTS

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

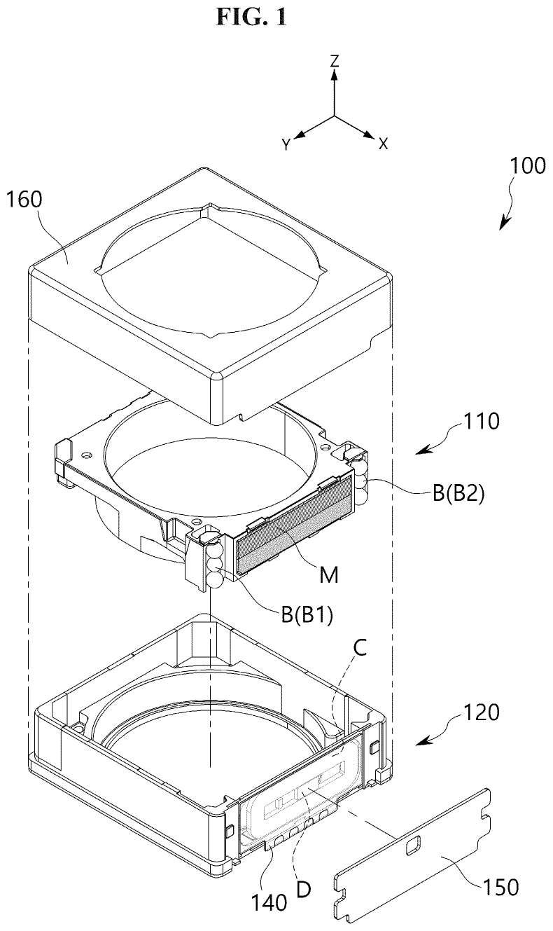

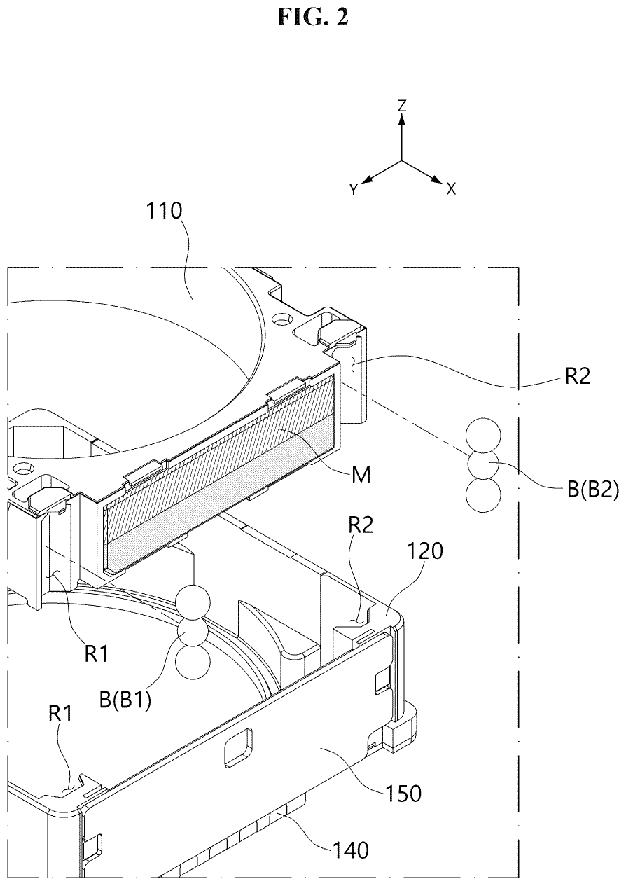

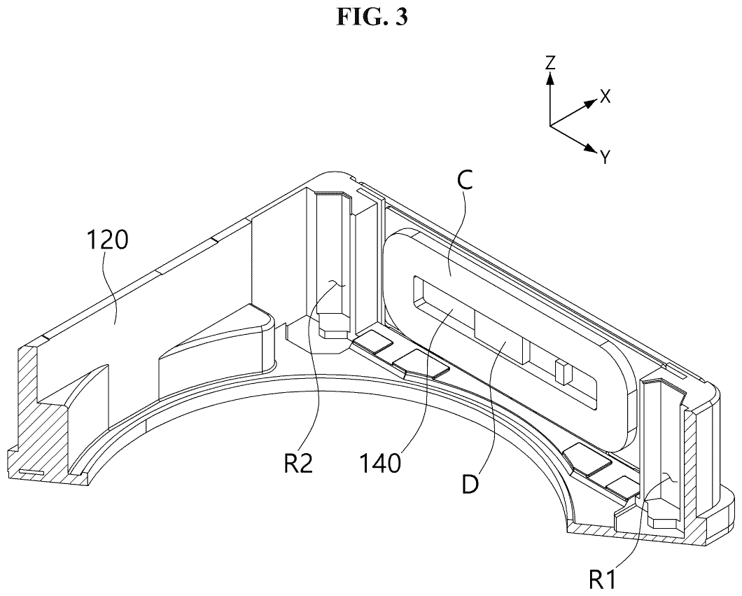

FIG. 1 is a drawing showing the configuration of an actuator for a camera (hereinafter, referred to as an ‘actuator’) according to a preferred embodiment of the present disclosure, and FIGS. 2 and 3 are drawings for explaining a ball B, a first rail R1, and a second rail R2 shown in FIG. 1.

Hereinafter, the general configuration of the actuator 100 of the present disclosure is described in detail, and the specific details of the present disclosure, such as the structural relationship between the ball B, the yoke plate 150, the magnet M, and the stroke H3, will be described later.

As shown in FIG. 1, the actuator 100 of the present disclosure may be configured to include a carrier 110, a housing 120, a circuit board 140, a magnet M, and a coil C, and may further include a case 160 that functions as a shield can according to an embodiment.

The actuator 100 according to the present disclosure corresponds to a device that implements AF or zoom function by linearly moving the carrier 110 forward or backward using electromagnetic force (magnetic force) between the coil C and the magnet M as a driving force.

Although the drawings show an embodiment in which AF is implemented alone, the actuator 100 of the present disclosure may be implemented not only in an actuator in which AF and OIS functions are applied in an integrated manner, but also in an actuator in which a reflector is applied.

The carrier 110 of the present disclosure may be located in the inner space provided by the housing 120, and corresponds to a mover that moves in the optical axis direction based on the housing 120. From a corresponding viewpoint, the housing 120 that supports linear movement of the carrier 110 corresponds to a relative stator.

According to an embodiment, at least one lens or lens assembly (hereinafter referred to as “lens”) may be mounted on the carrier 110. When the lens is mounted on the carrier 110 in this manner, the lens moves linearly by the movement of the carrier 110, and the relative distance between the lens and the image sensor is adjusted by the movement of the lens, thereby implementing an AF or zoom function.

The driving unit that moves the carrier 120 linearly in the optical axis direction is configured to move the carrier 110 in a specific direction using an external control signal or a detected signal system, and may be implemented by various means such as a shape memory alloy (SMA), a piezoelectric element, a micro electro mechanical system (MEMS), or the like.

However, considering the efficiency of device miniaturization, power consumption, noise suppression, space utilization, linear movement characteristics, precision control, etc., it is desirable that the driving unit is implemented with a configuration that utilizes the electromagnetic force (magnetic force) generated between the magnet and the coil as shown in the drawings.

In this regard, the coil may be installed in the mover and the magnet may be installed in the stator, but in order to increase the efficiency of electrical connection, structural design, etc., it is preferable that the magnet M is installed in the carrier 110, which is a mover, and the coil C is installed in the housing 120, which is a relative stator, as shown in the drawings.

Depending on an embodiment, a hall sensor for detecting the position of the magnet M1 or a sensing magnet, and an operation drive D for controlling the magnitude and direction of the current supplied to the coil C using a signal output by the hall sensor may be included. Since the hall sensor is typically implemented in the form of a single electronic component (chip) integrated with the operation drive D, it is not illustrated separately in the drawings.

The coil C, the operation drive D, etc. may be mounted on a circuit board 140, and it is preferable that the circuit board 140 is configured so that a portion thereof is exposed to the outside for interfacing with external modules, power supplies, external devices, etc.

A plurality of balls B are arranged between the carrier 110 and the housing 120. Specifically, the plurality of balls B may be a first ball group B1 arranged on a first rail R1 formed in at least one of the carrier 110 and the housing 120, and/or a second ball group B2 arranged on a second rail R2 formed in at least one of the carrier 110 and the housing 120 and parallel to the first rail R1.

In order to effectively guide the linear movement of the carrier 110, it is desirable that the ball belonging to the first ball group B1 is configured to be partially accommodated in the first rail R1. The ball corresponding to the second ball group B2 is also configured in the same manner. The first ball group and the first ball belonging to the first ball group are indicated by the same reference symbol B1 within the range where they do not need to be distinguished separately.

The drawings depict a configuration in which both the first and second ball groups B1 and B2 include a plurality of balls arranged in the optical axis direction, but one of the ball groups may include a single ball.

Although the drawings show an embodiment in which both the carrier 110 and the housing 120 are provided with the first rail R1, depending on an embodiment, only one of them may be provided with the first rail. In this case, the component in which the first rail is not provided may be provided with a groove or pocket portion that accommodates one or more balls (first balls) belonging to the first ball group B1 and prevents the first ball B1 from being released externally. The second rail R2 is also the same.

If the balls B1 and B2 are interposed between the carrier 110 and the housing 120 in this way, the mover (carrier) may linearly move more flexibly due to minimized friction caused by rolling, moving, rotation, point-contact with a facing object, etc. of the balls, and this may have the advantages of reduced noise, minimized driving force, and improved driving precision.

Regarding the rails R1, R2 on which the balls B1, B2 are arranged, one of the first rail R1 and the second rail R2 may be configured such that its cross-section (horizontal cross-section based on the optical axis direction) has a “V” shape, and the other may be configured such that its cross-section has a “U” shape.

If the cross sections of the first rail R1 and the second rail R2 are configured to have different geometrical characteristics in this way, the contact areas with the balls B1 and B2 and the rotational characteristics may be configured differently, thereby improving the driving characteristics, such as the movement linearity and driving efficiency of the carrier 110 moving in the optical axis direction.

If the second rail R2 having a “V”-shaped cross-section is provided in both the carrier 110 and the housing 120, the second rails R2 are arranged so that their open portions face each other and one or more balls (second balls) belonging to the second ball group B2 are arranged between them. Therefore, the second ball B2 comes into contact with both the second rail R2 of the carrier 110 and the second rail R2 of the housing 120 while being partially accommodated in the second rail R2.

The carrier 110 linearly moves precisely through the physical support of the second ball group B2 and the guiding of the second rail R2 by this physical structure.

Here, the cross-section being formed in a ‘V shape’ means that not only is it in the shape of the alphabet V, but it is also formed in a shape where the second ball B2 faces the inner surface of the second rail R2 at two points.

If the cross-section of the first rail R1 provided in the housing 120 is U-shaped, it may be desirable that the cross-section of the first rail R1 provided in the carrier 110 to face the rail R1 is V-shaped for the linear movement of the carrier 110.

The fact that the cross-section is in a ‘U shape’ means that it may have a certain amount of free space on the inner surface of the ball and the rail, including not only the shape of the alphabet U but also a trapezoidal shape, etc.

As an example, the drawings show an embodiment in which both the first and second rails R1, R2 provided on the carrier 110 have a V-shaped cross-section, and one of the first rail R1 and second rail R2 provided on the housing 120 has a V-shaped cross-section and the other has a U-shaped cross-section.

The housing 120 of the present disclosure includes a magnet M provided in the carrier 110 and a yoke plate 150 made of a magnetic material that generates an attractive force.

If an attractive force or suction force is generated between the magnet M and the yoke plate 150, in a state where the balls B1 and B2 are placed between the carrier 110 and the housing 120, the carrier 110 comes into close contact with the housing 120 (in the X-axis direction in the drawings), so that physical contact may continue between the balls B1 and B2 and the carrier 110, as well as between the balls B1 and B2 and the housing 120.

The axes shown in the drawings, terms referring to the axes, and terms such as “upper”, “lower”, “front”, “rear”, “vertical”, “horizontal”, or the like described with respect to the axes are intended to present a relative standard for describing an embodiment of the present disclosure, and it is obvious that these terms are not intended to specify any direction or location on an absolute basis. Of course, these terms may vary relatively depending on the location of a target object, the position or direction of view, or the like.

In the following explanation of the present disclosure, the Z-axis direction, which is a vertical direction of the carrier 110 and corresponds to a path along which light of a subject enters the lens, is defined as the optical axis direction, and two axes on the plane (horizontal plane) perpendicular to the optical axis direction (Z-axis) are defined as X-axis and Y-axis.

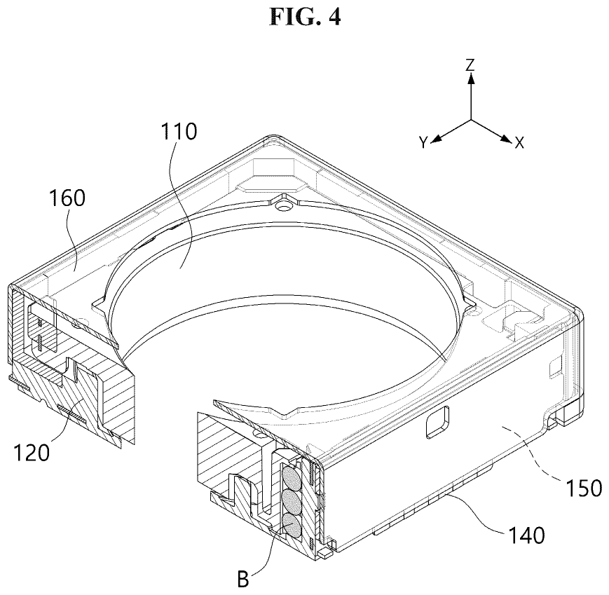

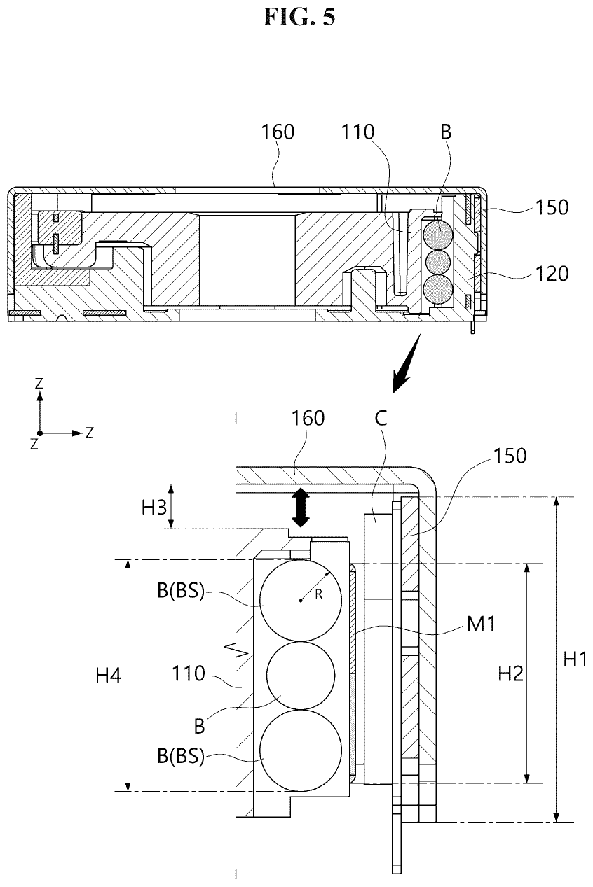

FIG. 4 is a partial cross-sectional view showing the ball B and the yoke plate 150, and FIG. 5 is a drawing for explaining the structural relationship between the yoke plate 150, the ball B, the magnet M, and the stroke H3.

As mentioned above, the yoke plate 150 of the present disclosure is configured to be installed in the housing 120, which is a relative stator, and generates an attractive force with the magnet M installed in the carrier 110, which is a mover.

Since the magnet M is a permanent magnet and the yoke plate 150 is made of magnetic material, the attractive force between them is constantly generated regardless of the movement of the carrier 110.

Since the ball B is arranged between the carrier 110 and the housing 120, even if the magnet M installed in the carrier 110 moves forward and backward in the optical axis direction due to the AF drive, the contact force between the housing 120 and the ball B and between the ball B and the carrier 110 must be maintained so that the linear movement of the carrier 110 due to the AF drive may be continuously performed without gap or tilt.

Therefore, it is desirable that the height H1 of the yoke plate 150 is designed to be greater than the height H2 of the magnet M, and also is configured to be greater than the sum (H2+H3) of the height H2 of the magnet M and the stroke H3, which is the range or length area in which the carrier 110 moves in the optical axis direction.

The plurality of balls B placed between the housing 120 and the carrier 110 are configured to physically support the carrier 110 and directly guide the physical movement of the carrier 110. As described above, the balls B may move with a degree of freedom in the optical axis direction, but do not have the same movement characteristics as the movement direction and movement distance of the carrier 110.

Therefore, the physical support or guiding of the ball B for the carrier 110 must be maintained, and the physical contact point (position of point contact) between the ball B and the carrier 110 must not go beyond the suction area by the magnet M and the yoke plate 150, so that the carrier 110 does not experience any posture problems such as tilting.

Therefore, it is desirable that the sum (H4+H3) (hereinafter referred to as a ‘first distance’) of the total height (stack height) (H4) of the plurality of balls B and the stroke (H3) is smaller than the sum (R+H1) of the radius of one of the plurality of balls B (hereinafter, referred to as a ‘contrast ball’) and the height of the yoke plate 150.

If all of the plurality of balls B have the same diameter, the contrast ball may be any one of the plurality of balls.

If the end of the carrier 110 (based on the optical axis direction) deviates from the center of the ball B located at the outermost side (based on the optical axis) among the plurality of balls B, the equilibrium support of the carrier 110 may be broken. Therefore, if the sizes of the plurality of balls B are not all the same, it is preferable that the contrast ball is a ball BS located at the outermost side among the plurality of balls B.

Since the diameters of the plurality of balls B cannot perfectly match each other and the movement and stop of the carrier 110 occur randomly during AF operation, when the carrier 110 moves in the optical axis direction, the ball B that actually comes into contact with the carrier 110 may change at any time.

Therefore, if the diameter of the ball BS (hereinafter, referred to as a ‘main ball’) placed at the outermost side among the plurality of balls B arranged in the optical axis direction is configured to be larger than the diameters of the other balls B, the carrier 110 may be induced to always face the main ball BS. Further, since the main ball BS with a relatively large diameter is placed at the outermost side among the plurality of balls, the possibility of the carrier 110 tilting may be relatively reduced.

The attached drawings show that the first ball group B1 and the second ball group B2 include the same number of balls, but depending on an embodiment, the first ball group B1 and the second ball group B2 may include different numbers of balls, and as mentioned above, one of the ball groups may include a single ball.

If a plurality of ball groups are arranged side by side between the housing 120 and the carrier 110 as above, it is preferable that the ‘total height of the plurality of balls B (H4)’, which is a component of the first distance (H4+H3), is determined as the total height of the ball group (hereinafter, referred to as a ‘support ball group’) with a relatively large total height among the plurality of ball groups.

In this case, it is desirable that the first distance (H4+H3), i.e., the sum of the height (H4) of the support ball group and the stroke H3, is smaller than the sum (R+H1) of the radius (R) of the ball placed at the outermost side among the balls belonging to the support ball group and the height H1 of the yoke plate 150.

If power of an appropriate magnitude and direction is applied to the coil C through the control of the operation drive D, a magnetic force (electromagnetic force) is generated between the coil C and the magnet M. As shown in the drawings, the coil C that generates the driving force is preferably designed to be in a height area that may cover the movement range (stroke) of the magnet M installed in the carrier 110.

Since the magnet M has weight and is installed on the carrier 110, which is a mover, leaving aside the fact that it may act as a load during operation, the driving force by the coil C is directly applied to the magnet M. Therefore, as the size of the magnet M (height in the optical axis direction) is larger, the driving force may be greater.

However, since the magnet M is a target to which the driving force is directly applied, if the driving force is applied to an area outside the physical support by the ball B, an incorrect posture of the carrier 110 may occur relatively easily.

Therefore, it is desirable that the height of the magnet M (based on the optical axis direction) is smaller than the sum (H4+R) of the total height (H4) of the plurality of balls B and the radius (R) of the ball BS placed at the outermost side among the plurality of balls. In this case, of course, the total height of the plurality of balls may be the height of the support ball group.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

Reference Symbols

| | |
|---|---|
| 100: actuator | |
| 110: carrier | 120: housing |
| 140: circuit board | 150: yoke plate |
| 160: case | C: coil |
| M: magnet | R1(2): first (second) rail |
| D: operation drive | B: ball |

What is claimed is:

1. An actuator for a camera, comprising:
a housing configured to provide an inner space;
a carrier configured to move in an optical axis direction based on the housing;
a magnet installed in the carrier to face a coil installed in the housing;
a yoke plate installed in the housing and configured to generate an attractive force with the magnet; and
a ball disposed between the housing and the carrier,
wherein a height of the yoke plate is greater than the sum of a height of the magnet and a stroke, which is a moving distance of the carrier by AF driving.

2. The actuator for a camera according to claim 1,
wherein the ball is provided in plurality so that the plurality of balls are arranged in the optical axis direction, and
wherein a first distance, which is the sum of a total height of the plurality of balls and the stroke, is smaller than the sum of a radius of a contrast ball, which is one of the plurality of balls, and the height of the yoke plate.

3. The actuator for a camera according to claim 2,
wherein the contrast ball is a ball placed at an outermost side among the plurality of balls.

4. The actuator for a camera according to claim 3,
wherein the ball placed at the outermost side is a ball with a largest diameter among the plurality of balls.

5. The actuator for a camera according to claim 1,
wherein the ball includes:
a first ball group arranged between the carrier and the housing; and
a second ball group arranged between the carrier and the housing and arranged parallel to the first ball group based on the optical axis direction,
wherein at least one of the first and second ball groups includes a plurality of balls, and
wherein the sum of the stroke and a height of a support ball group, which is a ball group with a larger total height among the first and second ball groups, is smaller than the sum of a radius of a ball placed at an outermost side among the balls belonging to the support ball group and the height of the yoke plate.

6. The actuator for a camera according to claim 2,
wherein the height of the magnet is smaller than the sum of a total height of the plurality of balls and a radius of a ball placed at an outermost side among the plurality of balls.
